(19) United States
(12) Patent Application Publication
(10) Pub. No.: US 2008/0072411 A1
(43) Pub. Date: Mar. 27, 2008

(54) Starting Component For The Production Of Saw Blades Or Bands And Method For The Production Thereof

(76) Inventors: Leander Ahorner, Waldhofen/Ybbs (AT); Gregor Innitzer, Wlen (AT); Helmut Ponemayr, Allhartsberg (AT)

Correspondence Address: ARNOLD & KNOBLOCH, L.L.P., 2401 FOUNTAIN VIEW DRIVE, SUITE 630, HOUSTON, TX, 77057, US

(21) Appl. No.: 11/632,691

(22) PCT Filed: Feb. 1, 2005
(86) PCT No.: PCT/EP05/00972

§ 371 Date: Sep. 19, 2007

(30) Foreign Application Priority Data
Jun. 25, 2004 (CH) 01073/04
Jul. 15, 2004 (CH) 01195/04
Jul. 16, 2004 (EP) 04016892.4

(51) Int. Cl. B23P 17/00

(52) U.S. Cl. 29/415; 76/112

(57) ABSTRACT

The present invention relates to a precursor component for the manufacturing of saw blades respectively saw bands, a method for the production of this precursor component, as well as a method for the production of saw blades, respectively saw bands. The above mentioned precursor component comprises at least a pre-manufactured carrier band respectively a pre-manufactured carrier disc, preferably a steel band respectively a steel disc and at least one pre-manufactured segment comprising of a precursor material for a cutting contour of saw blades respectively saw bands, wherein the carrier band respectively the carrier disc as well as the segment comprise a first and second face side, respectively and the first face side is more narrow than the second face side; and wherein the at least one carrier band respectively the at least one carrier disc is connected with the at least one segment via its respective narrow face side, such that by means of a separation of the final precursor component along a separation line which runs through the at least one segment two bi-metal bands respectively bi-metal discs can be generated which comprise one part of the at least one segment, respectively.

### 1. FIELD OF THE INVENTION

The present invention relates to a precursor component for the production of saw blades respectively saw bands as well as a method for its production. Further, the present invention relates to a method for the production of saw blades respectively saw bands from this precursor component.

### 2. BACKGROUND OF THE INVENTION

In general a composite steel blade or composite steel band is used as a precursor component for the production of saws with a hard and wear resistant tooth tip portion. Starting from the section of that steel blade narrow parts of tool steel are mounted onto the narrow site respectively narrow face of the elastic bendable steel blade respectively the carrier band.

Such a precursor component is also known under the expression bi-metal band or bi-metal blade based on the used different materials. The background for the use of tool steel respectively of other cutting materials lies in the fact that they provide a higher wear resistance for the tooth tip portions and thereby a higher lifetime for the final saw blade.

For the manufacturing of the saw blade from the above-mentioned composite a tooth profile respectively a tooth contour similar to the final saw blade is cut. The teeth resulting in this way comprise tip portions of tool steel, wherein the remainder of the saw blade comprises of the tough elastic steel of the carrier band. The above described cutting of the cutting edge contour however results in a high waste of tool steel, since the material of the cut intermediate space between the teeth is not used anymore.

Therefore in the EP 1 389 183 A2 the use of a carrier band in connection with segments of tough steel is described. This arrangement leads also to a high loss of material, since the segments are only filled by the tooth contour to be cut in a limited way. Further, a high time consumption is needed for the cutting, milling and grinding of the tooth contours to receive the final saw blade. This costly production steps further lead to a wear off of the used tools, which is also very cost intensive.

In the GB-A-451846 also a precursor component for the manufacturing of saw blades respectively saw bands as well as a method for its production is described, wherein a first and a second carrier band are connected with each other bi-means of a segment consisting of a high speed steel in order to produce to by metal bands by separating the precursor component. The production of such a known precursor component however requires additional costly rolling steps.

It is therefore the technical problem of the present invention to provide a precursor component for the production of saw blades respectively saw bands as well as a method for its production, which leads to a lower work effort compared to the prior art as well to a lower wear off of the tools during the production. Further the technical problem is to provide a more efficient and more cost-effective production of saw blades respectively saw bands.

### 3. SUMMARY OF THE INVENTION

Solutions for these technical problems of the present invention are presented in the independent claims 1 and 11. Further embodiments of the invention can be found in the dependent claims.

### 2. SHORT DESCRIPTION OF THE ACCOMPANYING DRAWINGS

The present invention is explained with respect to the preferred embodiments which are shown in the accompanying drawings. It shows:

FIG. 1 a preferred precursor component comprising of two carrier bands, which are connected to each other by a continuous segment.

FIG. 2 a preferred precursor component comprising of two carrier bands, which are connected with each other by means of a plurality of spaced apart segments;

FIG. 3 a preferred embodiment comprising of two carrier bands, which are connected to each other by a continuous segment, wherein a near contour cutting line runs through the precursor component;

FIG. 4 a preferred embodiment of a precursor component comprising of two carrier bands and a continuous segment, wherein the near contour cutting line as well the tooth contour which shall later be achieved are shown;

FIG. 5 an enlarged view of the portion designated with X from FIG. 4;

FIG. 6 a preferred precursor component with a plurality of segments, wherein the planned tooth contour is indicated;

FIG. 7 an enlarged view of the portion designated with X from FIG. 6; and

FIG. 8 a schematic view of tooth contours arranged in segments preferred according to the invention of different shape;

FIG. 9 a machining operation of the bi-metal band made prior the separation and a further meander shaped separation line (chain-doted line) intended for the separation into part bands as well as the lines for the later tooth profile within the part bands (dashed line) in an enlarged view from above (FIG. 9a) and in cross-section (FIG. 9b);

FIG. 10 the part bands separated along the separation line of FIG. 9;

FIG. 11 saw blades respectively saw bands resulting from the part bands of FIG. 10 by material removing machining;

FIG. 12 in view from above two finished saw blades respectively saw bands, as resulting from a preferred embodiment of the method according to the invention;

FIG. 13 in a plurality of partial figures (FIG. 13a-e) different steps of the way for the production of the saw blades respectively saw bands shown in FIG. 12;

FIG. 14 the punching of the (circular) insertion plates of cutting material from a larger sheet metal;

FIG. 15 the fixing of the insertion plates into the holes of the carrier band by means of a stamping process according to a preferring embodiment of the method according to the invention;

FIG. 16 the general sequence during brazing and subsequent hardening of the insertion plates according to a preferred embodiment of the method according to the invention;

FIG. 17 a top view of a carrier disk provided with holes for the manufacturing of a circular saw blade according the method according to the invention;

FIG. 18 the principal construction during welding with beams of the insertion plates with the carrier band according to a preferred embodiment of the method according to the invention; and

FIG. 19 two partial figures (FIG. 19a and 19b) of an alternative separation with respect to FIG. 13d and 13e of the carrier band along another separation line at which the later saw teeth abut each other with their cutting edges.

### 5. DETAILED DESCRIPTION OF PREFERRED EMBODIMENTS

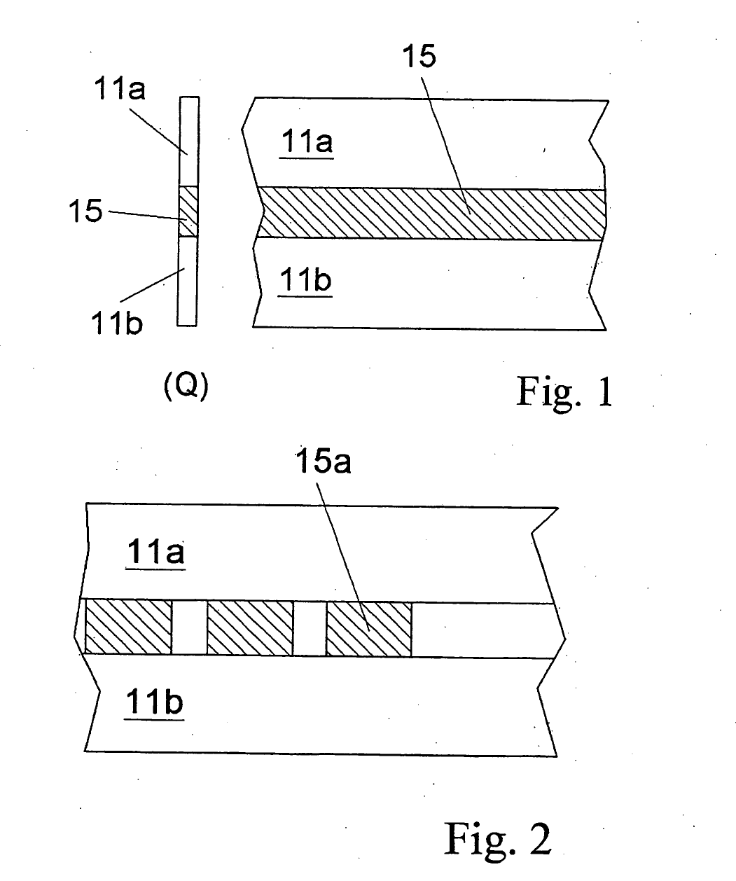

According to the invention, the precursor component for the manufacturing of saw blades respectively saw bands, is produced of at least one carrier band and at least one segment. Preferred embodiments of the present invention are for example schematically shown in FIGS. 1 and 2. They comprise a first carrier band 11a and a second carrier band 11b which preferably are produced of a tough rigid resilient steel. The first carrier band 11a and the second carrier band 11b are preferably connected with each other by means of at least one segment 15 or via a plurality of segments 15a. If a single segment 15 is used, this is arranged continuously between the first carrier band 11a and the second carrier band 11b.

The segments preferred according to the invention comprise of a hard and wear-resistant material, which after finishing of the production of the saw blade form the tooth tip of a possible tooth contour of a saw blade. The preferred inserted segments 15, 15a comprise different shapes and sectional profiles which result according to the saw application to be realized. By means of the design of the segment shape, preferably an efficient force transmission between a segment and carrier band during sawing is realized. One preferred segment profile guarantees the generation of the staggering or setting of the teeth also if the teeth respectively the tooth contour does not completely comprise of a bendable material for example ceramics or hard metal. To the single preferred embodiments of segments 15, 15a, is referred in more detail below.

Preferably, the single segment 15 or the plurality of segments 15a comprise(s) of high speed steel wire, which is also referred to as HSS wire. A further embodiment uses sheet metal, which consists of high-speed steel. Further preferred materials for the segments 15, 15a are hard metals, cermets, i.e. materials comprising of ceramic and metallic phases and poly-crystalline diamond (PCD). Further, all materials are suitable for the production of segments 15, 15a which guarantee the features of cutting tools and which can be permanently connected with the carrier bands 11a, 11b.

The embodiments preferred according to the invention which are shown in FIGS. 1 and 2, for the production of saw blades respectively saw bands have the advantage according to the invention that by means of a cutting process with little effort two bi-metal bands respectively bi-metal blades can be produced. It is also preferred according to the invention to connect a plurality of the precursor components which are shown in FIG. 1 and FIG. 2 by means of further segments to be arranged. From this, it follows that, by a simple cutting of the segments and the carrier bands, not only two but a higher number of bi-metal bands can be produced.

Based on the construction of the precursor components according to the invention, a compact arrangement is provided which facilitates the storage as well as the delivery of these precursor components relative to the number of the saw blades which can be manufactured. Further, only little process steps are required for the production of the precursor component of the invention compared to the production of the same amount of bi-metal blades. This leads to lower costs and to time reductions during the production of the precursor component according to the invention as well as the final saw blades respectively saw bands.

In the following, the method preferred according to the invention for the production of the above-mentioned precursor components and for the production of saw blades, respectively saw bands is described. The single preferred method steps which comprise the overall method can be combined arbitrarily into sub-methods, which can be done by a supplier and original equipment manufacturer of saw blades. So, all method steps which are described herein continuously are considered as steps for the manufacturing of the precursor component or as steps for the manufacturing of the saw blade.

In FIG. 1, a preferred precursor component is shown, which is made of the first carrier band 11a and the second carrier band 11b. The carrier bands 11a, 11b respectively comprise a first and a second face side, wherein the first face side is preferably narrower than the second face side. At the precursor component which is schematically shown in FIG. 1, the first face sides of the carrier bands 11a, 11b are arranged facing each other, and are connected by the continuous segment 15 which is arranged between them. As already explained above, the preferred precursor component is manufactured by less production steps compared to a comparable number of bi-metal bands. Besides the simplified manufacturing, the precursor component is also characterized by better storage possibilities and it can be transported with less effort.

Starting from the preferred embodiment of the precursor component shown in FIG. 1 by almost straight separation respectively cutting of the continuous segment 15, the precursor component is separated or divided into two bi-metal bands. The cutting within the continuous segment 15 preferably is done such that at both carrier bands 11a, 11b one part of the segment 15 remains. For the further manufacturing preferably a cutting contour is milled into the generated bi-metal bands. Into this cutting contour, the tooth tips are formed by the remainder of segments 15. After the generation of the tooth contour, preferably a hardening step of the saw blade precursor is done, which finally, if this is necessary, is finished by grinding or machined to exact dimensions.

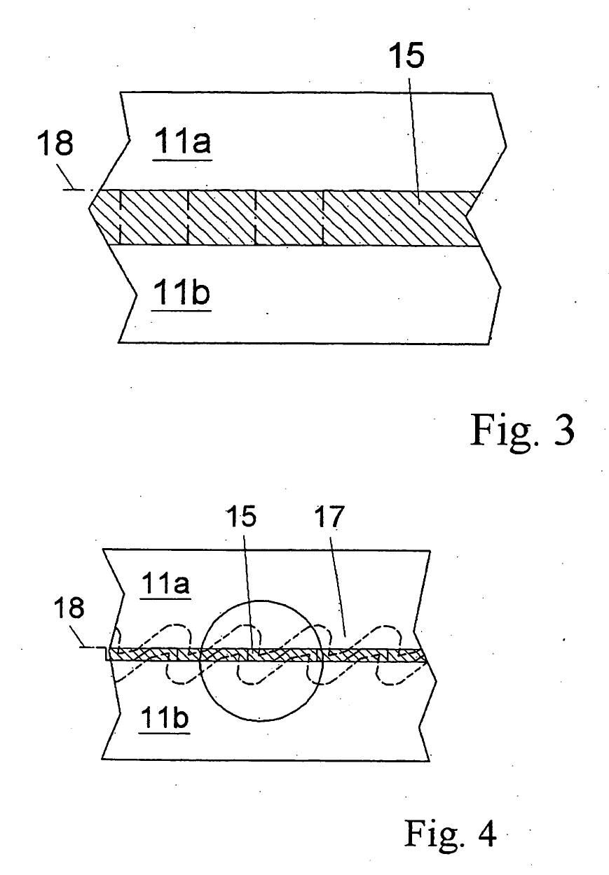

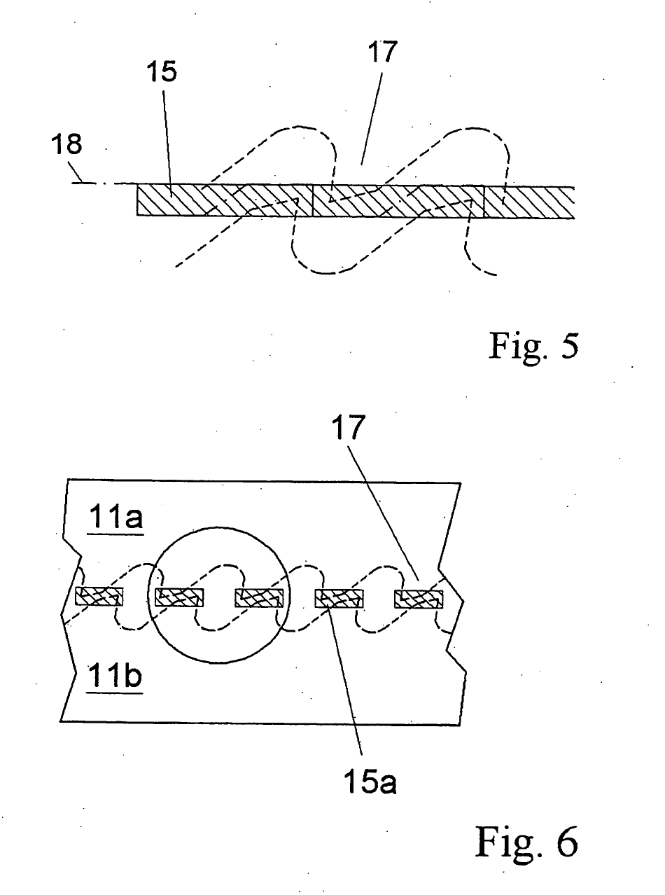

According to a further preferred embodiment of the present invention, the precursor component shown in FIG. 1 is cut along a cutting line 18 as it is shown schematically in FIG. 3. The cutting line 18 preferably runs within the continuous segment 15. It is also preferred that the cutting line 18 partially runs within the carrier bands 11a, 11b, if this facilitates the further production of the saw blade. Based on the run of the cutting line 18 two bi-metal blades respectively bi-metal band results, having staggered arranged segments 15. Based on its shape the cutting line 18 roughly provides the later cutting contour of the saw blades to be manufactured. This relationship between the shape of the cutting line 18 and the final cutting contour of the saw blade to be manufactured is schematically shown in FIGS. 4 and 5. Here, FIG. 5 shows an enlarged view of the circular area of FIG. 4.

Since the later contour of the saw blade is almost copied by the run of the cutting line 18, this production step is also referred to as near-contour cutting. By means of the accuracy of the near-contour cutting, further manufacturing steps as e.g. milling or grinding can be reduced to a minimum or even be saved.

Preferably, after the cutting or the near-contour cutting, a hardening step of the combination of carrier band and segment follows. Since the cutting or the near-contour cutting is made under the influence of heat, for example by means of lasers, in the cut materials mechanical stresses, structure changes and/or glass phases or the like remain. These often negative effects decrease during the hardening step. Besides the elimination of the above-mentioned negative effects to a large extent, the hardening step is the basis for the later grinding of the generated bi-metal bands. Without the hardening process, the grinding would be negatively affected by the way-to-soft materials, if e.g. the grinding tools glaze. Additionally, the near-contour cutting in combination with the hardening facilitates the later grinding, since, due to the accuracy of the near contour cutting, only little amounts of material have to be removed. On this basis, preferably a milling of the precursor component is saved, respectively.

According to a further preferred embodiment of the precursor component according to the invention, which is shown schematically in FIG. 2, a first carrier band 11a and a second carrier band 11b is connected to each other by means of a plurality of segments 15a. As the already described continuous segment 15, also the segments 1 5a are produced of a suitable cutting material.

The segments 15a are regularly, periodic and/or irregularly arranged along the longitudinal direction of the carrier bands 11a, 11b, e.g. to reduce vibration during a later saw process or even to eliminate them at all. The distance of the plurality of segments 15a is additionally adapted to the tooth contour 17, which is produced later (cf. FIGS. 4, 5, 6, and 7). The relationship between the distance of the segments 15a and the later cutting contour 17 is preferably based on the fact that the segments 15a after the manufacturing form the tip portions of the saw blade to be produced.

Due to the preferred arrangement of the segments 15a within the areas, in which later the tooth contours are produced and by eliminating of costly cutting material within the intermediate portions were later no teeth contour is produced, an efficient material reduction is obtained as well as an efficient use of the existing material and thereby a more cost efficient manufacturing of saw blades.

According to a further preferred embodiment of the present invention, the precursor component according to FIG. 2 is separated in such a way that at opposite face sides of the carrier bands 11a, 11b sections of the segments remain. To achieve the final cutting contour of the saw blade, a milling and/or grinding and final hardening is done or a milling and/or hardening and a final grinding.

According to a further preferred embodiment of the present invention, the precursor component shown in FIG. 2 comprising of the carrier bands 11a, 11b and the connecting segments 15a is hardened. Since the segments 15a are connected with the carrier bands 11a, 11b via comparably short sections, only a comparably low warping of the precursor component according to the invention results during the heat treatment during the hardening. This warping is based on the different expansion behavior of the materials which are used for the carrier bands 11a, 11b and the segments 15a. Due to the lower warping, the adaptation of the materials of carrier band and segment to each other is facilitated, to compensate for the remaining warping. Further, the reduced or almost compensated warping forms a better starting point for the further manufacturing of the precursor component. As a further advantage, the hardening process forms the basis for a subsequent grinding, since the grinding of hardened material compared to non-hardened material happens with reduced tool impact. This is due to the fact that hardened materials e.g. do not lead to a “glazing” on the grinding tools.

Further, based on the arrangement of the plurality of segments 15a between the carrier bands 11a, 11b, a precursor component is provided which is comparable to a near-contour cut double bi-metal strip. Therefore, preferably only a minor material removal is needed, to obtain the final shape of the saw blade. This saves preferably the milling step and further facilitates in combination with the hardening process an immediate exact manufacturing of the saw contour by means of the grinding. Therefore, due to the above-described manufacturing of the precursor component, manufacturing steps and thereby costs during the manufacturing of saw blades, respectively saw bands are saved.

For the further manufacturing of the preferred hardened precursor component, a separation of the segments 15a is done, such that at opposite face sides of the carrier bands 11a, 11b opposite sections of the respectively cut segment 15a remains. The hardened bi-metal bands respectively bi-metal strips made in this manner are given the shape of the final cutting contour by means of grinding, punching or other preferred forming steps.

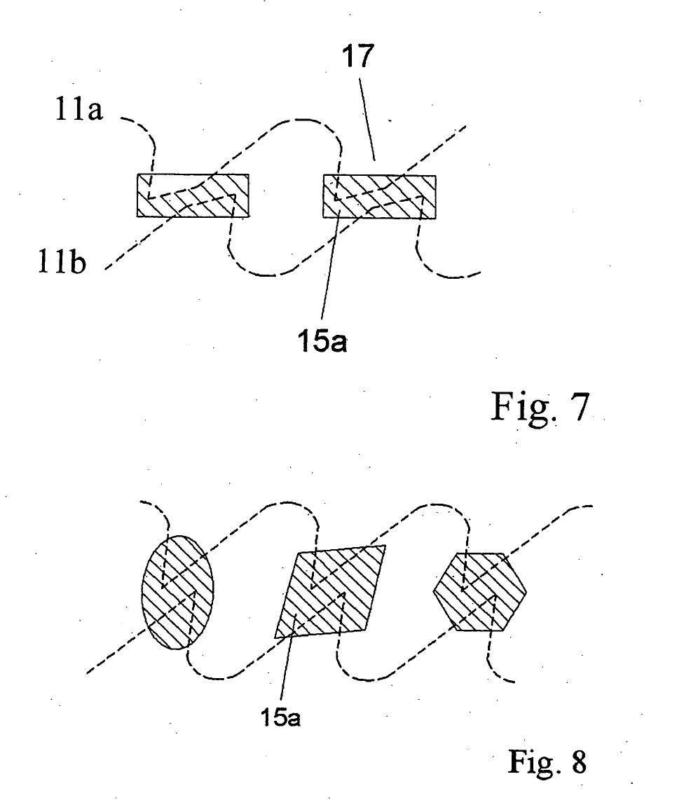

According to a further preferred embodiment of the present invention, the precursor component shown in FIG. 2 is separated after the hardening by means of a near-contour cutting process within segments 15a. The near-contour cutting may preferably extend also over the segments 15a up to the carrier bands 11a, 11b. The near-contour cutting leads to tooth contours 17, which are exemplarily shown in FIGS. 6 and 7. This preferred design of the manufacturing process leads to an optimal use of the material, such that loss of expensive cutting material is reduced and in this way costs are saved. Further, the near-contour cutting leads to a tooth contour, which only requires less finishing, to achieve the final geometries of the saw blade to be generated. Since the herein manufactured precursor component is already hardened, the finishing is done by means of grinding processes, which also require low tool loads and thereby also low costs.

In order to further optimally use the material used for the segments 15a and to save costs in this way, preferably the cutting contours of two later tool tips are arranged within one segment 15a. This is shown according to a preferred embodiment in FIGS. 6 and 7. According to this embodiment, the rounded tooth contour areas are arranged close to each other, whereas the straight arranged portions—here preferably almost perpendicular—are arranged near the outer edge of the segment 15a. Additionally, the size of the segment 15a is adapted to the desired tooth contour in such a way that possibly less material has to be cut away as excess. Further, the tooth contours are arranged preferably in such a way in the segment that the above-mentioned straight portions are arranged opposite to each other. This leads particularly at a relatively narrow, pointed and to the top extending tooth contour to material savings.

The amount of excess material or the excess which has to be considered for the near-contour cutting of the segments is related to the thermal stress during the cutting. This results from the thermally loaded or thermally damaged zones, which result during cutting. Therefore, it is also preferred according to the invention to reduce the thermal load during cutting or in general during the machining to select in such a way, that the thermally loaded zones are kept small and thereby the excess is minimized.

According to a further preferred embodiment of the present invention, besides the material of the segments 15, 15a also the shape of the segments is varied as seen from the side as shown in FIGS. 1 and 2. This variation of the shape preferably has the goal to generate e.g. a not only straight arranged borderline between segment and carrier band.

This borderline between carrier band and segment is loaded during the later saw process by heavy mechanical stresses. By means of the preferred run of this borderline, a mutual supporting between segment and connected carrier band happens. To this end, it is preferred to use segments 15a in a curvilinear or angular shape, e.g. a round, oval, equally polygonal or quadrangular shape. Exemplary shapes are schematically shown in FIG. 8, and explain the principle which should be used herein.

The different shapes of the segments 15a are preferably inserted into recesses which are correspondingly shaped to the segments 15a into the corresponding carrier band 11a, 11b. Due to this arrangement, the borderline between segment and carrier band runs curvilinear, straight, angular or in any arbitrary shape, which supports the stability of the later saw blade comprising of carrier band and segment. Preferably, the different shapes of the segments 15a are connected within the corresponding recesses of the carrier bands by means of welding, brazing or other suitable connecting or mounting methods.

According to a further preferred embodiment of the present invention, the segments 15, 15a comprise a profiled shape in cross-section. The herein considered cross-sectional face runs perpendicular as well as to the drawing plane of FIGS. 1 and 2 as also to the visible longitudinal axis of the carrier band 11a, 11b, shown therein. The cross-section preferably comprises the shape of a parallelogram, trapezium, irregular quadrangle, or the like. The profiling of the cross-section of the segments 15, 15a is preferably used with cutting materials which cannot be bent for the setting of the tooth contours of the later saw blades. Preferred according to the invention, the profile and section of the used segments already provides a setting-like arrangement. Further it is preferred to produce these setting-like arrangements by means of machining methods, e.g. grinding. On this basis, it is preferably according to the invention possible to achieve a tooth contour which comprises similar characteristics as it would be achieved by setting of usual saw blades also by the use of e.g. ceramic cutting materials, hard metal, PCD or the like.

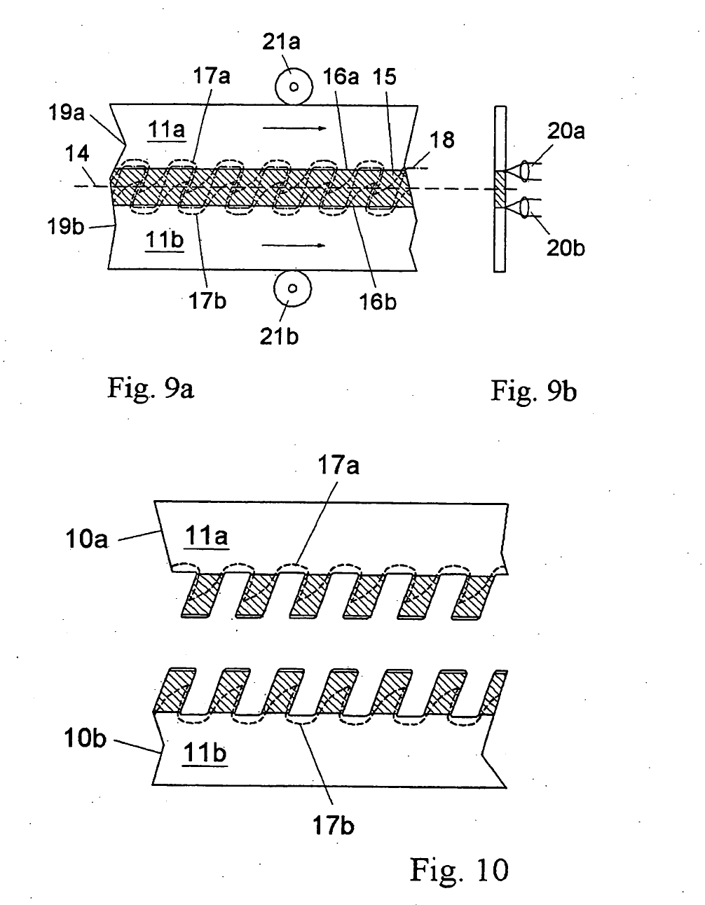

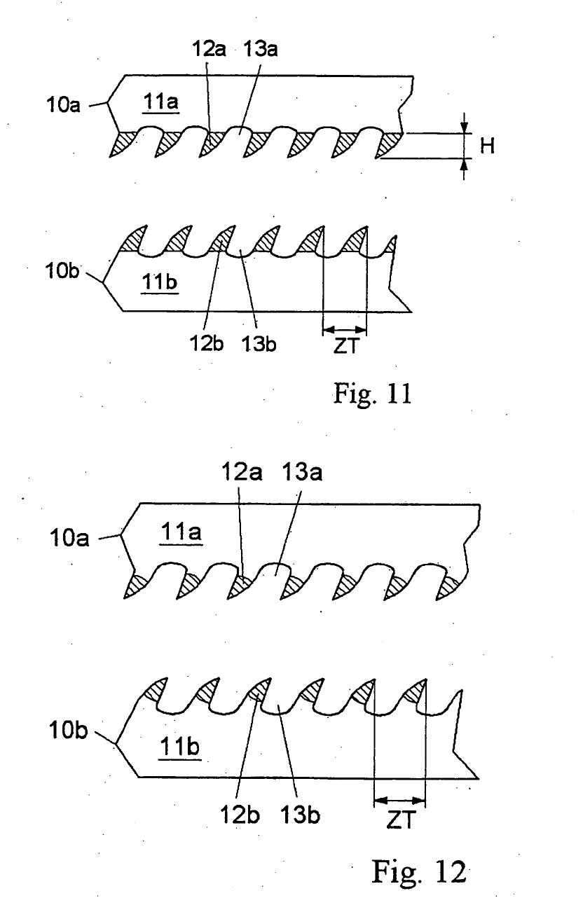

According to FIGS. 9 to 11 a further embodiment of the invention is shown. Herein the connection is done via weld seams 16a, b, which are generated by highly energetic beams 20a, 20b in form of laser beams or electron beams (schematically shown in FIG. 9b by two beam paths). Since the welding is done in a central area and symmetrically to the center line 14 of the bi-metal band, a distortion of the band generated by the welding can securely be avoided. Since the width B of the strip 15 is preferably chosen such that it approximately equals the height (H in FIG. 11) of the sections of the cutting teeth (12a, b in FIG. 11) which comprise of the cutting material. To this end the loss of cutting material during the machining of the teeth profile is reduced to a minimum.

The band-shaped bi-metal precursor material advantageously can be machined simultaneously at both opposite arranged outer edges 19a, b before it is separated into two equal part bands (FIG. 10). Such a machining ensures that the final saw blade respectively saw band is guided with its rear edge without difficulties in guiding roles or other guiding elements. For the machining of the outer edges 19a, b an edge machining device 21a, b is provided, which is only schematically shown in FIG. 9 and which works material forming (for example by rolling) or material removing (for example by grinding or the like) to particularly provide an equally rounded outer edge.

The separation according to FIG. 10 is done along a separation line 18 which runs in longitudinal direction and meander-like through the segment 15, which is shown in FIG. 9 by a chain-dotted line. The separation line 18 as shown in FIG. 9 is an example, only. Of course, other separation lines are conceivable, to achieve an optimal use of the cutting material from the segment 15 for the saw teeth of both later saw blades respectively saw bands. The period of the separation line 18 corresponds to the spacing (tooth pitch ZT in FIG. 11) of the later saw blades respectively saw bands. It is also conceivable that one period comprises a plurality of different teeth. If in the precursor material a plurality of segments of cutting material are arranged in parallel as it is shown in FIG. 11 of the U.S. Pat. No. 3,766,808 a correspondingly number of parallel separation lines result. It is ssential for the separation line 18 that the separation along the separation line 18 in longitudinal direction of the band (in direction of the center line 14) forms consecutive segments of the segment 15 which are alternatively allocated to the one and the other part band generated thereby. This indenting of both separated part bands 10a, b (FIG. 10) ensures that the segment 15 with the cutting material is optimally used and during the formation of the tooth profile 17a, b with the cutting teeth 12a, b and teeth gap 13a, b a minimum of waste is generated. By means of the minimization of the material loss a minimization of the manufacturing time and the tool wear is provided, since considerably less material has to be depleted.

The separated part bands 10a, b of FIG. 10 finally are subjected to a material removing manufacturing during which the final saw teeth 12a, b are formed (FIG. 11). The saw teeth 12a, b thereby can be consist totally or partially of the cutting material.

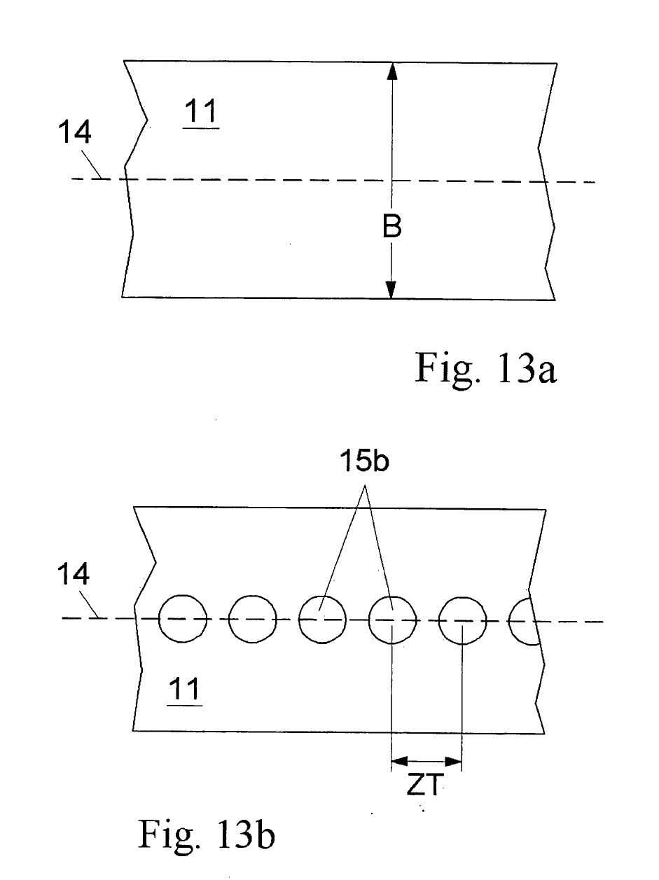

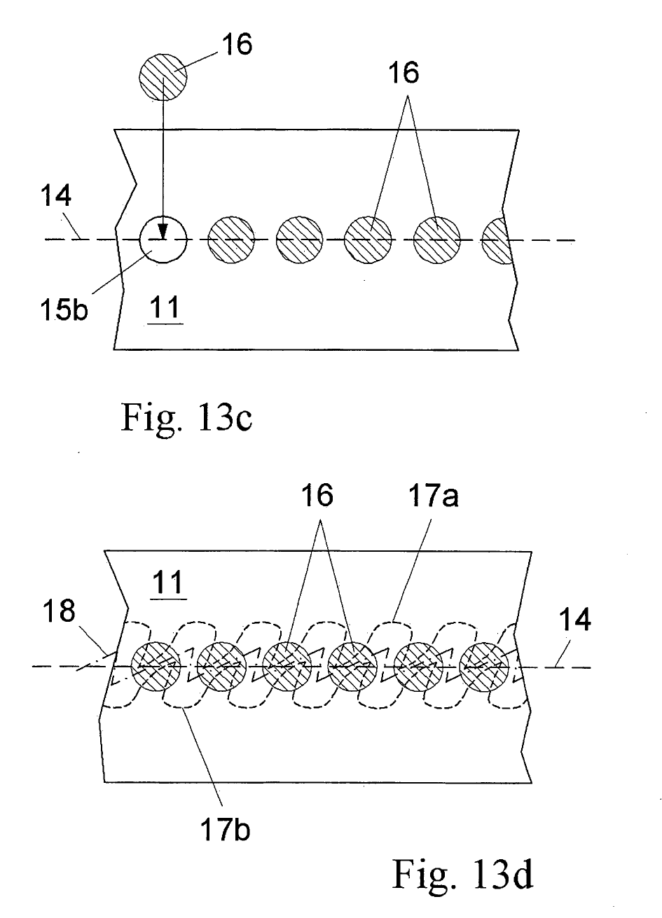

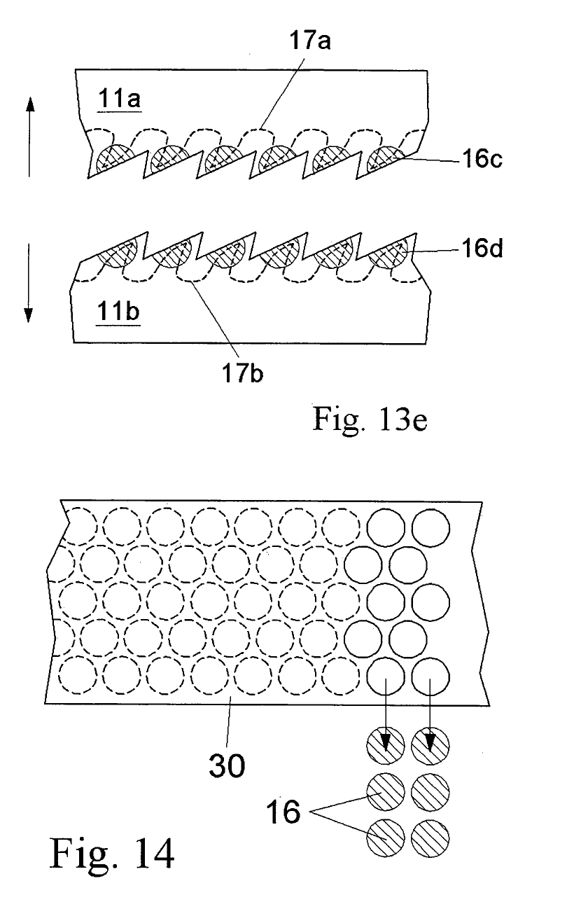

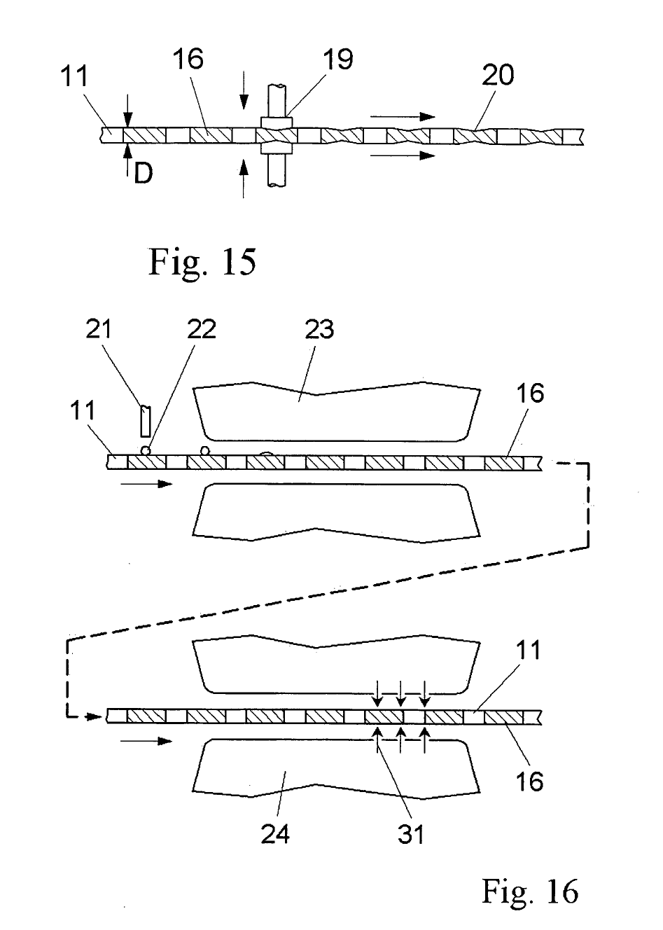

Finally, in FIGS. 12 to 19 another embodiment of the invention is shown, in which only one single carrier band with therein inserted insertion plates forms the precursor component. In FIG. 13 in a plurality of partial FIGS. 13a to 13e different steps for the manufacturing according to the invention of a pair of saw blades respectively saw bands 10a, b is shown as they are shown in FIG. 12. According to the FIG. 13a the starting point is a carrier band 11 of a suitable carrier band material (a steel or the like) as it is known many times from the initially mentioned prior art. The thickness D of the (preferably manufactured by rolling) carrier band 11 (FIG. 15) is in the range between approximately 0.5 to 3 mm. The width B of the carrier band is chosen such that it is larger or equally the same as the width of the final saw blades respectively saw bands 10a, b.

In a first step consecutive holes 15b are inserted into the carrier band 11 according to FIG. 13b by means of punching, laser cutting or another suitable method along respectively within the center line 14 of the carrier band 11. The distance of the holes 15b (center point of the hole to center point of the hole) corresponds to the spacing ZT of the final saw blade respectively saw band 10a, b. In the shown example the holes 15b have a circular edge contour. However, they can have also other edges, for example the shape of a polygon, and ellipse or the like. The circular edge contour thereby has the advantage of the high symmetry and easy possibility to manufacture respectively to machine.

Into the holes 15b in carrier band 11 according to FIG. 13e suitable insertion plates 16 are inserted whose thickness corresponds preferably to thickness D of the carrier band 11. The insertion plates 16 comprise of a material, which is preferably suitable for cutting teeth and which is different from carrier band 11. Particularly suitable for this application is a tool steel, which can be hardened, particularly a high speed steel (HSS), as it is known in plurality of forms from the tool technique. The insertion plates 16 are preferably punched or cut out from a larger sheet metal 30, as shown in FIG. 14, wherein due to the simplified manufacture of a sheet metal a considerable cost advantage is achieved with respect to the prior art. A high use of material is thereby achieved by means of a possibly tight packed arrangement of the punching holes.

However, it is also conceivable to use insertion plates 16 of a hard metal, like it is for example used for cutting plates. The insertion plates 16 preferably have the same shape and the edge contour as the holes 15b, such that they completely fill the holes 15b and abut with their outer edges closely the inner edge of the holes 15b. During the consecutive connecting with material bond the insertion plates 16 are then connected with the carrier band 11 via the complete length of its edge. The insertion plates 16 can particularly with respect to the later tooth shape also be shaped in another way, such that they only abut and are connected with the carrier band 11 by means of specific sections of its edge.

If the insertion plates 16 are inserted into the holes 15b of the carrier band 11 the further manufacturing steps are facilitated by means of fixing the insertion plates 16 within the holes 15b until the final connecting with material bond with the carrier band in its position. A fixing can particularly preferably be achieved according to FIG. 15 by means of a stamping step within a stamping device 19. During the stamping step by means of a suitable stamping die an impression 20 is generated in the center of the insertion plates 16, respectively. The material displaced by means of the impression 10 flows to the outside and increases the diameter of the insertion plate 16, such that the edge of the plate 16 is pressed against the inner edge of the hole 15b, and fixes the position. However, it is also conceivable to fix the insertion plate 16 by positioning of edge-sided welding points.

After the fixing of the insertion plates 16 within the holes 15b of the carrier band 1 the insertion plate 16 and the carrier band 11 are connected with each other at the edge of the plates by means of a connecting with material bond. A brazing method according to FIG. 16 with a subsequent hardening process is preferred for insertion plates 16 of a tool steel which can be hardened. To this end the carrier band 11 with the inserted and fixed insertion plates 16 is guided through a brazing device 23 in which it is preferably heated by induction. Before the corresponding section of the carrier band 11 enters the brazing device 23 a suitable brazing metal for example copper brazing metal is applied to the corresponding insertion plate. If the carrier band 11 with the brazing metal 22 enters the brazing device 23 the brazing metal 22 and the carrier band 11 are heating up to the required temperature (for example ≦1150° C.), the brazing metal 22 melts and is drawn into the ring gap between the insertion plates 16 and the carrier band 11. The heat introduced during the brazing into the carrier band can advantageously be used to perform a subsequent hardening process. To this end the carrier band 11 according to FIG. 16 is immediately after the brazing provided to a hardening device 24 where the insertion plates 16 are hardened correspondingly to the valid hardening specification for its material, particularly by means of quenching with an injected liquid or gaseous quenching medium 31.

Instead of a brazing a welding method, particularly by means of a laser beam or an electron beam can be used (FIG. 8) as a method for connecting with material bond if the insertion plates 16 comprise of a material which can be welded. A corresponding beam 28 and/or 29 of a beam source 26 respectively 27 is guided single or both-sided along the edge contour of the insertion plates 16.

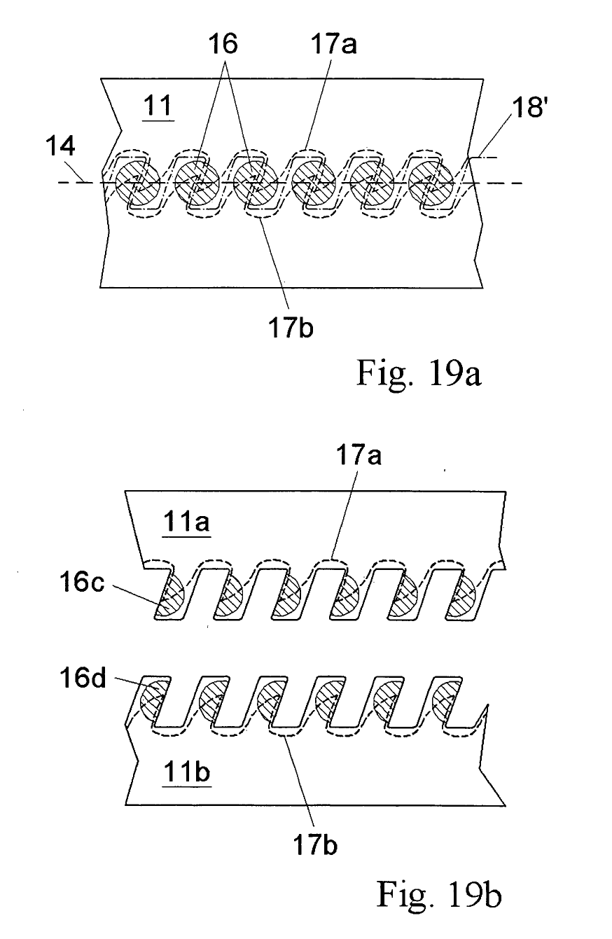

After the carrier band 11 and the insertion plates 16 in this way are connected with material bond with each other the carrier band 11 is separated according to FIGS. 13d and 13e (or according to FIG. 19a and 19b) along a predetermined separation line 18 respectively 18′ into two similar part bands (carrier bands 11a, b in FIG. 12). The zigzag shaped separation line 18 respectively 18′ is chosen with respect to the both final tooth profiles 17a and 17b of both separated saw blades respectively saw bands 10a, 10b in such a way that the insertion plates 16 are halved respectively into two insertion plate section 16c, d, wherein each plate half respectively each insertion plate sections 16c, d is sufficient for the formation of a cutting tooth. Both separated part bands 11a, 11b correspond to each other by a rotation around 180°. To this end it is ensured that by the same manufacturing steps two similar saw blades 10a, b are generated. From the two present part bands 11a, 11b according to FIG. 13e with the braced plate halfs the tooth profiles 17a, b with its saw teeth 12a, b and intermediate tooth gaps 13a, b can be formed by means of material removing machining, until their saw blades respectively saw bands 10a, b are provided in its final shape as it is shown in FIG. 12. Although at the separation line 18 of FIG. 13d the later cutting teeth 12a, b abut each other within the insertion plates 16 with their backsides, the separation line 18′ of FIG. 19a provides a separation at which the final saw teeth 12a, b abut each other by means of its cutting edges. In connection with other shapes of the insertion plates 16 and tooth profiles 17a, b also other separation lines are conceivable.

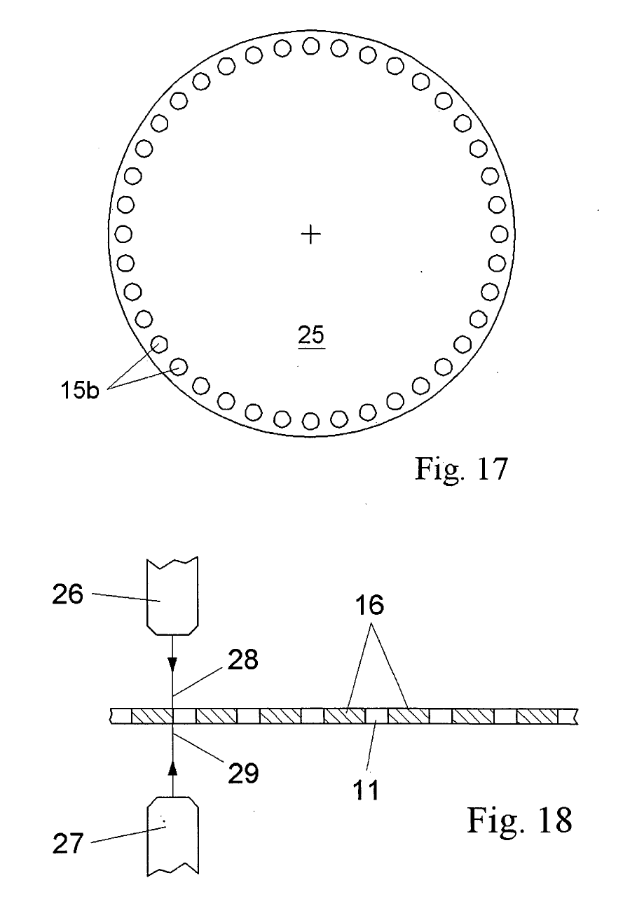

If a circular saw blade has to be manufactured by means of the method according to the invention it is started according to FIG. 17 from a circular carrier disc 25 into which in its edge portion circumferentially the holes 15b are inserted. Into the holes 15b then correspondingly the insertion plates 16 are inserted, fixed and connected with the carrier disc 25 by means of a connecting with material bond (by brazing or the like) and hardened if necessary. Subsequently by a material removing machining the desired tooth profile is generated.

To sum it up, by means of the above described embodiments of the invention a method for the manufacturing of a bi-metal saw blade or bi-metal saw band or bi-metal circular saw blade results which comprises the following features and advantages:
Due to the use of flat insertion plates a sheet metal can be used as the precursor material for the teeth which is easily and cost efficiently to be manufactured from which the single insertion plates are punched out or cut out.
Since the cutting material is only inserted in the area of the later teeth into the carrier band the material use is reduced. This is particularly valid for the pair-wise manufacturing of saw blades respectively saw bands by separation of a wider carrier band with centrally inserted insertion plates.
Since the insertion plates are positioned more within the carrier band respectively the carrier disc and are surrounded by the carrier material from all sides the thermally induced deformation during brazing or welding of the plates is low. This is particularly valid if the insertion plates are arranged symmetrically within the center line of the carrier band.
The manufacturing can be done with a carrier band and insertion plates whose thickness equals approximately the thickness of the later saw blades, wherein costly rolling steps can be avoided.

### LIST OF REFERENCE SIGNS

10a, b saw blade, saw band, part band
11, 11a,b carrier band
12a, b saw teeth
13a, b teeth gap
14 center line
15, 15a segment(s) (cutting material, HSS or the like)
15b hole
16 insertion plates
16a, b welding seam
16c, d insertion plate section
17, 17a, b tooth contour, tooth profile
18, 18′cutting line, separation line
19 stamping device
19a, b outer edge
20 impression
20a, b beam (laser beam, electron beam)
21 brazing metal application device
21a, b edge machining device
22 brazing metal
23 brazing device
24 hardening device
25 carrier disc
26, 27 beam source (laser, electron beam)
28, 29 beam (laser beam, electron beam)
30 sheet metal
31 quenching medium
B width (carrier band, segment)
D thickness (carrier band, insertion plates)
H height of the saw teeth 12a,b
ZT spacing

1. A precursor component for the manufacturing of saw blades respectively saw bands, comprising:
a) at least a first and a second pre-manufactured carrier band preferably a steel band; and
b) at least a pre-manufactured rectangular segment comprising of a precursor material for a cutting contour of saw blades, respectively saw bands; wherein
c) the first and second carrier band as well as also the segment respectively comprise a first and a second face side, and wherein the first face side is more narrow than the second face side; and wherein
d) the first and second carrier band is connected with the at least one segment at its narrow face side, respectively such that by means of a separation of the final precursor component along a separation line which runs through the at least one segment, two bi-metal bands can be produced, which comprise a part of the at least one segment, respectively.

2. (canceled)

3. Precursor component according to claim 1, wherein the at least one rectangular segment consists of high speed steel wire (HSS wire), high speed cutting edge wire, high speed steel sheet metal, ceramics, cermets, hard-metal, PCD and/or other suitable cutting materials.

4. Precursor component according to claim 3, wherein the width of the high speed steel wire varies between the standard width and the double standard width.

5. Precursor component according to claim 1, wherein the least one segment extends over the total length of the first and the second carrier band or wherein a plurality of segments is arranged in regular or periodic distances along the first and the second carrier band.

6. Precursor component according to claim 5, wherein the precursor component with the plurality of segments is hardened.

7. (canceled)

8. Precursor component according to claim 1, wherein the at least one segment is connected with the almost straight first face side of the first and second carrier band, respectively.

9. Precursor component according to claim 1, wherein the at least one segment is connected within a recess within the first face side of the first and/or second carrier band, wherein the recess is complementary shaped to a portion of the corresponding segment.

10. Precursor component according to claim 1, wherein the at least one segment comprises a profiled cross section face perpendicularly to the longitudinal axis of the first and the second carrier band.

11. A method for the production of a precursor component for the production of saw blades respectively saw bands, particularly according to claim 1, comprising the following steps:
a) providing at least a first and a second pre-manufactured carrier band, preferably a steel band;
b) providing at least one pre-manufactured rectangular segment, comprising of a precursor material for a cutting contour of saw blades respectively saw bands, wherein the carrier band as well as the segment comprises a first and a second face side, respectively, and wherein the first face side is more narrow than the second face side;
c) connecting the at least first and second pre-manufactured carrier bands with the at least one segment at its narrow face side, respectively.

12. (canceled)

13. Method according to claims 11, wherein the connection is done by means of welding.

14. Method according to claim 13, wherein the connection is done by means of electron beam welding or by laser welding.

15. Method according to claim 11, wherein the connecting is done by brazing.

16. Method according to claim 11, further comprising a separating of a plurality of segments of a wear resistant precursor material.

17. Method according to claim 16, wherein the separation is done by punching.

18. Method according to claim 16, wherein the precursor material consists of a high speed steel wire (HSS wire), high speed cutting edge wire, high speed steel sheet metal, ceramics, cermet, hard-metal, PCD and/or other suitable cutting materials.

19. Method according to claim 13, further comprising a heat treatment of the first and the second carrier band and the at least one segment.

20. Method according to claim 13, further comprising straightening of the first and the second carrier band and the at least one segment.

21. Method according to claim 13, further comprising a soft annealing and/or temper pass rolling of the first and second carrier band and the at least one segment.

22. Method according to claim 13, further comprising hardening of the first and second carrier band and the at least one segment.

23. Method according to claim 22 further comprising cutting the precursor component to achieve at least two saw blades respectively saw band precursors.

24. Method according to claim 23, wherein the cutting is a near contour cutting.

25. Method according claim 24, wherein the near contour cutting of the precursor component is done prior the hardening of the precursor component.

26. A method for the production of a saw blade respectively saw band from a precursor component according to claim 1, comprising the following step:
cutting the precursor component, preferably with a cutting laser in such a way that two precursors for saw blades respectively saw bands result.

27. Method according to claim 26, wherein the cutting is done in such a way that after the cutting at the oppositely arranged sides of the first and the second carrier band one part of the segment remains existing, respectively.

28. Method according to claim 26, wherein a near contour cutting is done.

29. Method according to claim 26, wherein the cutting is done in such a way that a contour is cut into the precursor component.

30. Method according to claim 29, wherein the contour is cut with an oversize for the final machining.

31. Method according to claim 28, further comprising the arranging of the cut of the contour in such a way that the first and the second carrier band with at least one connecting segment comprises almost oppositely arranged tooth contours or laterally displaced tooth contours.

32. Method according to claim 28, wherein the contour is cut into the at least one segment or into the at least one segment and the first and/or second carrier band.

33. Method according to claim 28, further comprising an interlacing of the tooth contours within one segment, respectively to almost completely use the segment by the tooth contours.

34. Method according to claim 25, further comprising a hardening of the precursor component before or after the cutting.

35. Method according to claim 26, further comprising a grinding of a contour of a saw blade respectively a saw band.

36. Method according to claim 26, further comprising separating of the first and/or second carrier band in longitudinal direction, to generate at least two precursor components or at least two precursors for saw blades respectively saw bands.

37. Method for the production of a saw blade respectively saw band according to claim 26, wherein the precursor component is separated into two part bands along a separation line, which extends in longitudinal direction through the segment in such a way that in longitudinal direction subsequent sections of the segment alternatively remain at one of both part bands.

38. Method according to claim 37, wherein the separation in both part bands is done in such a way that the two part bands are equal.

39. Method according to claim 37, wherein the width (B) of the segment is approximately the same as the height (H) of the saw teeth.

40. Method according to claim 37, wherein the two carrier bands consist of the same metal, particularly a tough rigid steel.

41. Method according to claim 37, wherein for manufacturing of the precursor component the segment is welded on both sides with a carrier band respectively by means of laser welding or electron beam welding.

42. Method according to claims 41, wherein the segment consists of a hardable tool steel, particularly a high speed steel and is hardened after the welding with the carrier bands.

43. Method according to claim 37, wherein prior the separation of the precursor component from the both carrier bands and the intermediate arranged segment both outer edges are worked.

44. Method according to claim 37, wherein the separation of the precursor component into the two part bands is done by means of laser beam cutting.

45. Method according to claim 37, wherein the segment and both carrier bands comprise the same thickness.

46. Method according to claim 45, wherein the thickness of the segment and both carrier bands is the same as the thickness of the final saw blades respectively saw bands.

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)
